(19) United States
(12) Patent Application Publication
(10) Pub. No.: US 2016/0001468 A1
(43) Pub. Date: Jan. 7, 2016

(54) A METHOD OF PREPARING A MOULD FOR INJECTION MOLDING

(71) Applicant: BENNETT PRECISION TOOLING NSW PTY LTD, Hornsby (AU)

(72) Inventors: Justin Clarke, Hornsby (AU); Mark Bennett, Hornsby (AU); James Bennett, Hornsby (AU)

(21) Appl. No.: 14/770,701

(22) PCT Filed: Feb. 24, 2014
(86) PCT No.: PCT/AU2014/000167

§ 371 Date: Aug. 26, 2015

(30) Foreign Application Priority Data
Feb. 26, 2013 (AU) 2013900647

(51) Int. Cl. B29C 33/64; B29C 45/40; B29C 33/58

(52) U.S. Cl. CPC B29C 33/64; B29C 33/58; B29C 45/40; B29K 2083/005

(57) ABSTRACT

Method of preparing a mould for injection moulding are disclosed including the steps of: placing the mould in a chamber; creating an atmosphere in the chamber which includes vaporised siloxanes. The step of creating the atmosphere may include the steps of: introducing liquid siloxanes into the chamber; and applying heat to cause vaporisation of at least some of the liquid siloxanes.

### TECHNICAL FIELD

The present invention relates to methods of conducting injection moulding operations and to methods for preparing moulds for injection moulding. The invention has particular application in overmoulding operations using liquid silicone.

### BACKGROUND TO THE INVENTION

Liquid silicone rubber materials are often used to manufacture articles with medical and food related applications. Typically, liquid silicone is provided in two parts, Part A and Part B. These are mixed and injected into a heated mould cavity. The heat of the mould vulcanises the silicone. The mould is opened and the silicone article is removed.

In an overmoulding operation, an article is formed by firstly forming a first stage of the article from any material, such as plastic, steel or silicone. This first stage is then put into a second mould in which it is “overmoulded” with silicone. The silicone bonds to the first stage and vulcanises to yield a composite article formed partly from silicone and partly from the other material of the first stage.

In order to achieve good adhesion between the silicone and the first stage, so called “sticky” silicone products have been developed which include adhesion promoters. However, this has given rise to problems with the sticky silicone becoming adhered to parts of the mould, thereby greatly increasing the potential for damage to the article when it is being removed from the mould.

One technique which has been devised to address the problem of adhering of sticky silicone to mould parts involves setting up an injection moulding machine with a mould to be used for overmoulding, and initially running the machine with a regular silicone material for a period of time. Then, after a number of moulding cycles, which can be of the order of 1000 cycles, the machine is stopped and reconfigured to be supplied with a “sticky” silicone material. The articles produced during the initial running phase are treated as waste and are discarded. Moulding operations then proceed using sticky silicone and problems of the sticky silicone adhering to the mould are not experienced or at least reduced.

It has been found that, during the period of initial operation with normal silicone, a layer of residue builds up on the mould which inhibits the adhesion of articles subsequently moulded from sticky silicone to the mould. However, in order to achieve the build up of residue a significant amount of material is wasted, and time is spent both running the machine with no useful output being produced, and to set up the initial supply of normal silicone and then later change that over to the sticky silicone.

Furthermore, should the mould be cleaned or serviced, then the residue must again be created on the mould surfaces requiring a repeat of the initial running phase.

There remains a need for improved techniques for avoiding adhesion of sticky silicone to mould parts.

### SUMMARY OF THE INVENTION

In a first aspect the present invention provides a method of preparing a mould for injection moulding including the steps of placing the mould in a chamber; creating an atmosphere in the chamber which includes vaporised siloxanes.

The step of creating the atmosphere may include the steps of introducing liquid siloxanes into the chamber; and applying heat to cause vaporisation of at least some of the liquid siloxanes.

The siloxanes may include cyclosiloxanes.

The siloxanes may include polydimethylcyclosiloxanes.

The polydimethylcyclosiloxanes may include hexamethylcyclotrisiloxane, octamethylcyclotetrasiloxane, decamethylcyclopentasiloxane, dodecamethylcyclohexasiloxane, tetradecamethylcycloheptasiloxane or octadecamethylcyclooctasiloxane.

The chamber may be provided in the form of a substantially gas tight vessel and the step of applying heat is carried out by placing the vessel in an oven.

In a second aspect the present invention provides a method of conducting an injection moulding operation utilising an injection moulding machine and at least one injection mould including the steps of: preparing the mould by exposing surfaces of the mould to evaporated siloxanes prior to installing the mould in the injection moulding machine.

### DETAILED DESCRIPTION OF THE PREFERRED EMBODIMENT

Embodiments of the invention involve treatment of moulds prior to their installation and use with injection moulding machines. The treatments proposed give rise to a coating on the mould which has proven successful in addressing problems of adhesion of sticky type silicone materials during subsequent moulding operations.

In an injection mould, the shape for moulding is often defined by a so called “mould insert” which is removably mounted in the mould itself. In the following described methods, a mould using mould inserts is referred to. The mould inserts of the mould are treated.

### Method 1

1. Fabricate a box from approx 12 mm aluminium plate to house the silicone and inserts during treatment.
2. Coat a sheet of aluminium foil (180×100 mm) with Part B Dow Corning Silastic HC-595-94 (www.dowcorning.com) approximately 2 mm thick.
3. Clean any dust and oil from the inserts.
4. Secure the inserts inside the die cast box. Space them evenly throughout the box.
5. Place the aluminium foil with Dow Corning silicone into the box and put on the lid.
6. Make sure heat treatment oven is below 70° C.
7. Turn on heat treatment oven and set both sides to 200° C.
8. Place the box into the heat treatment oven and start timing.
9. After 2 hours, remove the box from the heat treatment oven and remove the lid.
10. Place the inserts on a suitable table to cool in air for 30 minutes.

### Method 2

1. Fabricate a box from approx 12 mm aluminium plate to house the silicone and inserts during treatment.
2. Coat a single layer of aluminium foil (180×100 mm) with mixed Part A & B Dow Corning Silastic HC-595-94, approximately 2 mm thick.
3. Clean any dust and oil from the inserts.
4. Secure the inserts inside the die cast box so that they are suspended in the middle of the box. Space them evenly throughout the box.
5. Place the aluminium foil with Dow Corning silicone into the box and put on the lid.
6. Turn on the heat treatment oven and wait until oven is stable, both sides at 175° C.
7. Place the box into the heat treatment oven.
8. Turn off the heat treatment oven and start timing.
9. After 45 minutes, remove the box from the heat treatment oven and remove the lid.
10. Start the oven heating again as it will have dropped to around 160° C.
11. Replace the aluminium foil and silicone with a new sheet of aluminium foil.
12. Repeat from step 7 three times (so 4 strips of silicone are cured for 45 mins each).
13. Remove the box from the oven.
14. Place the lid, with the inserts on top, on a suitable table to cool in air for 30 minutes.

Testing has shown that mould inserts treated in the method above do not suffer from problems of adhesion of so-called “sticky” silicone. They are therefore able to be set up into an injection moulding machine which can be run from the outset using sticky silicone. The initial run in period using regular silicone is not required.

Mould inserts treated by the methods above can be set aside and used at a later date and problems of adhesion still do not occur. This treatment can also be used on mould die blocks or any similar surface in contact with sticky silicone during moulding.

Without wishing to be bound by theory, the inventors believe that the methods described above result in the mould parts becoming covered by a coating consisting of low molecular weight cyclic siloxanes.

These siloxanes are the volatiles within uncured silicone that react to cause the curing of silicone. These volatiles diffuse from the core of the silicone to the surface, where it then evaporates. This process occurs both when it is uncured and when it is cured, until there are no more present.

The majority of the siloxanes are cyclic siloxanes concerned are known as D4 to D10. Also known as unreacted cyclic oligomer starting materials, these are functional silicone volatiles that cause the silicone to cure. Cyclic siloxanes are used in the manufacture of silicone, as well as cosmetic and personal care products. They have a backbone of structure of alternating oxygen and silicon atoms, with hydrocarbon groups attached to the silicon side chain.

Within the group D4 to D10, it is believed that siloxanes D4 to D8 play a significant role. The boiling points of these materials are given below:
D4 Octamethylcyclotetrasiloxane 175.8° C.
D5 Decamethylcyclopentasiloxane 210° C.
D6 Dodecamethylcyclohexasiloxane 245° C.
D7 Tetradecamethylcycloheptasiloxane 154° C.
D8 Octadecamethylcyclooctasiloxane 290° C.

Methods of the invention result in vaporisation of the siloxanes by various processes including a combination of boiling and evaporation. Higher temperatures results in higher volatisation of cyclic siloxanes, potentially increasing the rate of deposition of the coating. In order to maximise the release of the volatiles from a given amount of silicone, cured or uncured, it has been found to be beneficial to maximise the ratio of exposed surface area to volume of silicone.

It can be seen that embodiments of the invention have at least one of the following advantages:
Reduction of waste which was created by performing initial moulding operations using regular silicone.
Saving of time both in setting up a supply of regular silicone and later swapping to a supply of “sticky” silicone and also in avoiding the initial moulding operations, which resulted in waste articles

The embodiments of the invention described above involved use of commercially available liquid silicone products which contain siloxanes. This is a convenient source of siloxanes. Similarly, the siloxane materials themselves could be obtained and used in embodiments of the invention.

In the embodiments described above the mould inserts and silicone products were put into an airtight aluminium box which was then itself put into an oven for heating. In other embodiments the box may have integrated heating elements which avoids the use of a separate oven.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A method of preparing a mould for injection moulding comprising:
placing the mould in a chamber;
creating an atmosphere in the chamber which includes vaporised siloxanes.

2. A method according to claim 1, wherein the step of creating the atmosphere comprises:
introducing liquid siloxanes into the chamber; and
applying heat to cause vaporisation of at least some of the liquid siloxanes.

3. A method according to claim 1, wherein the siloxanes comprise cyclosiloxanes.

4. A method according to claim 1, wherein the siloxanes comprise polydimethylcyclosiloxanes.

5. A method according to claim 4, wherein the polydimethylcyclosiloxanes comprise at least one of hexamethylcyclotrisiloxane, octamethylcyclotetrasiloxane, decamethylcyclopentasiloxane, dodecamethylcyclohexasiloxane, tetradecamethylcycloheptasiloxane or octadecamethylcyclooctasiloxane.

6. A method according to claim 2, wherein the chamber is provided in the form of a substantially gas tight vessel and the step of applying heat is carried out by placing the vessel in an oven.

7. A method of conducting an injection moulding operation utilising an injection moulding machine and at least one injection mould comprising:
preparing the mould by exposing surfaces of the mould to evaporated siloxanes prior to installing the mould in the injection moulding machine.

8. A method of conducting an injection moulding operation according to claim 7, wherein the step of preparing the mould is carried out in accordance with claim 1.
